(19) United States
(12) Patent Application Publication
(10) Pub. No.: US 2012/0003353 A1
(43) Pub. Date: Jan. 5, 2012

(54) Bread Product And Method

(76) Inventor: Dennis Arthur Lonergan, Medina, MN (US)

(21) Appl. No.: 12/828,601

(22) Filed: Jul. 1, 2010

(51) Int. Cl. A21D 8/04

(52) U.S. Cl. 426/19; 426/62

(57) ABSTRACT

A leavened dough and method of its preparation are provided. The dough is formed by shaking a mixture of water, flour and leavener. The dough formation does not require the use of a mechanical mixing device, but can utilize only a substantially closed container that can be shaken with the flour water inside.

The present invention relates to a packaged dry mix bread product and a method of making bread from the mix without conventional bread dough development.

### BACKGROUND

In the practice of making bread and bread like items, flour is mixed with water and other ingredients including leavener, such as yeast, to form a dough. The leavener, preferably yeast, provides carbon dioxide to expand the dough and produce a cell structure in the cooked dough. Typically, the dough is mixed to peak development to form what most bread consumers consider desirable bread attributes, such as texture and appearance. After mixing, the dough is allowed to rise, after which the dough is cooked to set the structure of the dough to form the finished bread. Typically, the rising dough is punched down and allowed to rise again. This is well known in the art of bread making. Many different types of bread and bread like products are made this way, both commercially and at home. Such breads are typically made using wheat flour that contains gluten, a protein that forms the gas retention properties of the developed dough. These methods require mechanical mixing to develop the dough.

Another method has come about recently and that is the so called Artisan bread process. It too requires mechanical mixing to form the dough. A book entitled My Bread by Jim Lahey (copyright 2009 and published by W. W. Norton & Company, Inc. of New York, N.Y.) discusses the making of Artisan bread. Rather than mix the dough to full development, the mixed dough is allowed to rise for a long period of time say, for example, 24 hours before baking. The final cooked product is like the bread products produced using the “mix to full development” process. This process is sometimes referred to as a “no knead” method, but still requires handling by the preparer. Dough prepared by this method is also very high in moisture content.

Both these methods require the use of a mechanical mixer and containers to hold the dough during mixing and development. These processes require cleanup of the mixing device and the containers.

The present invention allows for the production of bread like items without the required mechanical mixing. It was surprisingly discovered that bread like products can be easily made and produce a high quality cooked item without mechanical mixing of the dough, and that a dough can be formed by simply shaking the bread ingredients together in a container followed by an extended fermentation step. As seen in FIG. 3, the dough formed by shaking is highly irregular and its appearance indicates mixing is needed to provide a usable dough. This “mix by shaking” can take as little as about 5 seconds when the mixture is allowed to ferment for at least about 8 hours. This dough formation method eliminates the need for mixing bowls and utensils and their cleanup, and more importantly, transforms bread making into a simple, fool-proof process.

While it is known that batters can be easily formed by shaking or mechanical mixing, there are two attributes which differentiate a batter from a dough. First, a batter has a much higher water content, and hence fluidity, than a dough and hence permits intimate and uniform mixing of the ingredients. This facilitates the uniform hydration of the flour in a batter by shaking and hence the formation of a flowable viscous liquid, commonly known as a batter. Second, batters do not rely on development of the gluten in the batter to achieve the desired baked product. In fact, the aim is to avoid development of a gluten matrix. Batters, when cooked produce a crumb structure.

A dough is a plastically deformable solid and was not considered formable without mechanical agitation with a mixing device to obtain sufficient and uniform hydration of the flour and alignment of the gluten molecules (e.g. dough development) throughout the dough mass to permit bread making. Hand kneading has also been used as a form of mechanical mixing with a mixing device, the hands.

### SUMMARY

The present invention involves the provision of a method of making a bread like food item. The method includes adding a predetermined amount of water to flour containing gluten, such as a wheat flour or a blend of flours including gluten. The water is added in an amount in the range of between about 55% and about 95% by weight of flour (as is) making the total water in the mix, including the water in the ingredients (flour typically has about 12% moisture) present in the range of between about 75% and about 125% by weight of dry flour. The flour and added water are in a closable container. The container can be a rigid container or a flexible container such as a bag made of a flexible film. After adding the water to the flour, the container is at least substantially closed. The flour and water are mixed by shaking the container sufficiently to form an agglomeration of the water, flour and other ingredients. The initial agglomeration is allowed to ferment and quiescently develop to form dough from the action of yeast, a leavener, for a period of time of at least about 8 hours. The fermented dough can be handled, which will decrease its volume, and then either cooked (e.g., baked) directly or allowed to rise for a short period of time (e.g., 30-45 minutes) after which it is then cooked (e.g., baked).

The invention also involves a product for making a bread like product. The product can include a sealed package that contains flour with gluten and yeast leavener. A sealable container is provided with the product. The sealable container has a volume potential of at least about 200% in excess of the volume of the dry mix (e.g., flour, salt and yeast) in the sealed package and water to be added.

### BRIEF DESCRIPTION OF THE DRAWINGS

FIG. 1 is a perspective view of a product package with portions broken away to show contents in the container.

FIG. 2 is an enlarged perspective view of a container used to mix contents of the package with water.

FIG. 3 is a photograph of a flour/water agglomeration formed by mixing flour and water in the container of FIG. 2 by shaking.

FIG. 4 is a photograph of a dough formed by mixing with a dough hook for 8 minutes.

FIG. 5 is a photograph of two loaves of bread baked with the right loaf having been formed from a dough formed by shaking and fermenting in accordance with the invention, and the left loaf being formed by conventional mixing.

FIGS. 6A and 6B illustrate a pair of alternate containers usable to store dry ingredient(s) and for admixing flour and water.

FIGS. 7A and 7B illustrate a second alternate container usable to store dry ingredient(s) and for admixing flour and water.

### DETAILED DESCRIPTION

FIG. 1 illustrates a packaged food product 1 including an outer sealed package 2 which may be made of any suitable material compatible with containing food products. As shown, the package 2 is a rectangular solid having sidewalls 3A-D, a bottom wall 4 and a top wall 5. The package is preferably constructed to provide means to open same, e.g., a tear strip, (not shown) as is known in the art. A suitable package material can be paperboard. Graphics, branding, labeling information and instructions 7 can be provided on the exterior of the package 2.

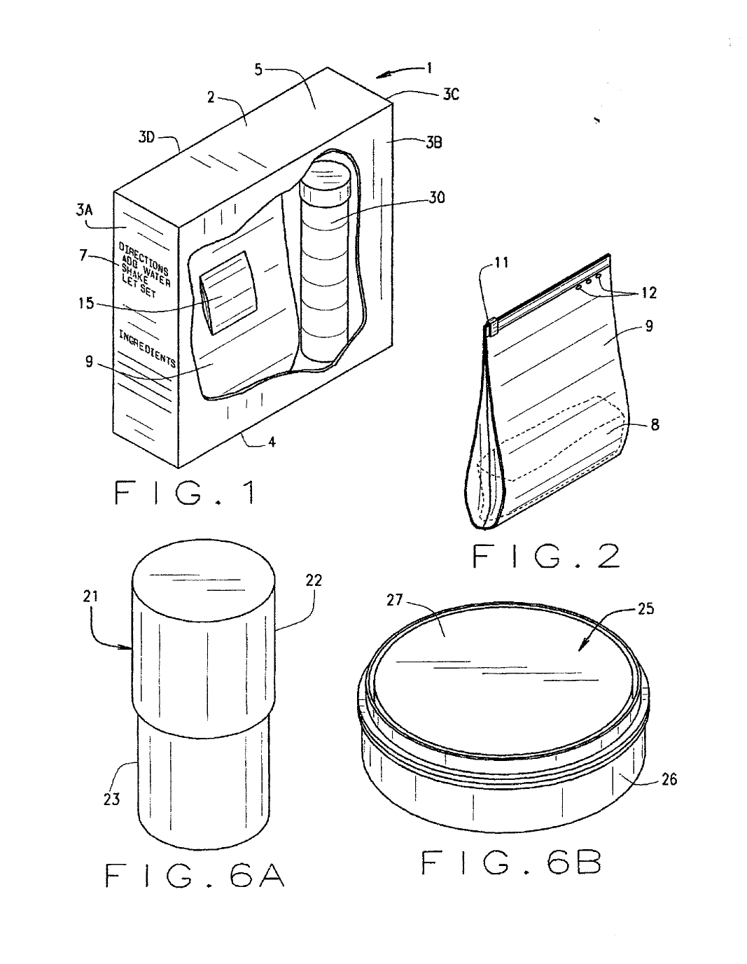

The package 2 contains flour 8 (FIG. 2) preferably in a sealable container 9 such as a water impermeable plastic bag with a closure device 11 that permits selective opening of the container 9 and its reclosure for a purpose later described. The container 9 may also be vented if fermentation and development are to take place in the container. The container 9 is also preferably resistant to moisture migration to help maintain the original moisture content of the flour 8. A suitable material can be polyethylene or polypropylene. Venting may be achieved by at least partial opening of the closure device 11 after mixing or may be provided with one or more vents such as holes 12 through one or more walls of container 9 at a location that will allow content mixing without appreciable loss of materials. The holes 12 may be sealed with a closure device such as a piece of tape that is operable to selectively close the holes. Venting may also be achieved by constructing the container 9 with a material which has a permeability to carbon dioxide sufficient to vent the carbon dioxide produced by the yeast. When closed, the container 9 has a volume potential (or fully expanded volume) in excess of the volume of the contained flour and other components of the bread in the package 2, plus the volume of the recommended amount of water to be added of at least about 200% and up to about 400%, and more preferably at least about 250% and preferably in an amount in the range of between 250% and about 300%. The container 9 can be used to contain the formed agglomeration (described below) during fermentation and development if desired and is preferably vented to allow the escape of fermentation gases as by the holes 12 or opening of a closure 11. The agglomeration (formed by admixing the dry and wet ingredients as described herein) or fermented dough (herein collectively referred to as doughy mass) may be removed from the container 9, when it is a flexible bag, by simply turning the bag inside out to expose the contained material. It is preferred to remove the doughy mass from contact with the container by starting the release of the material at an edge portion and working to an opposite edge portion of the area in contact with the container 9.

As shown, the container 9 can be in the form of a closable flexible bag. The container 9 may include a mechanical closure device 11 such as those found on resealable plastic bags that have slide locks or those that have a rib that fits into a corresponding groove. An adhesive closure may also be used.

The package 2 can also contain a predetermined amount of water in a sealed container 30. It has been found that the amount of water added to the flour 8 can be an important factor. This can be due to the fact that people have trouble accurately measuring water using typical household measuring cups because of their large cross sectional area, the difficulty in holding them level and the fact that many are not accurately calibrated or manufactured. The ability to judge the amount of water when there is a meniscus is also limited. A measuring device for water may also be provided that has a small transverse cross sectional area, much like a graduated cylinder that would make measuring a proper amount of water easier and more accurate if water is not included in the package 1. The container 30 can serve this function in subsequent uses and need not be provided in additional kits. If water is provided in the kit, it is provided in an amount in the range of between about 55% and about 95%, preferably in the range of between about 65% and about 85%, and most preferably in the range of between about 70% and about 80% by weight of flour as the flour exists in the package. This water amount is based on the flour having a 12% moisture content. The total water in the mixed water and flour would be in the range of between about 75% and about 125%, preferably in the range of between about 85% and about 110%, and most preferably in the range of between about 95% and about 105% by weight of dry flour. As known to one skilled in the art, the optimal amount of water in dough is a function of several factors, including the type of bread being made, the moisture content of the flour and the absorption value of the flour. These amounts of water are also the same as those to be provided and added by the preparer.

The water may optionally come from a liquid food which contains a high percentage of water. Examples include milk (skim, 1% fat, 2% fat or whole milk), cream, beer and fruit juices. When these items are used, their percentage in the formula is adjusted to reflect the percentage of water in each item. For example, skim milk contains approximately 10% of non-water components. Thus, if the formula called for 100 grams of water, approximately 111 grams of skim milk would be used in its place.

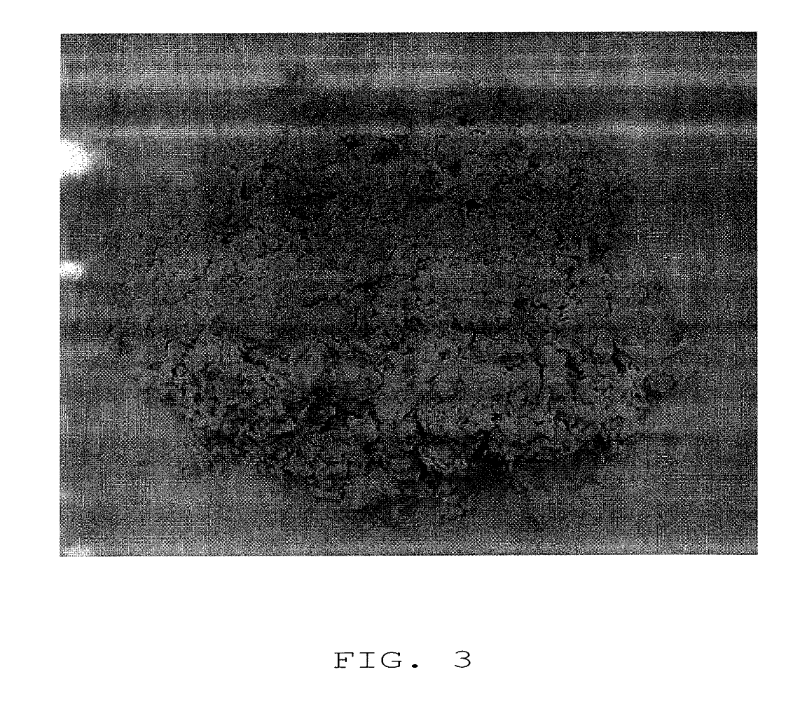

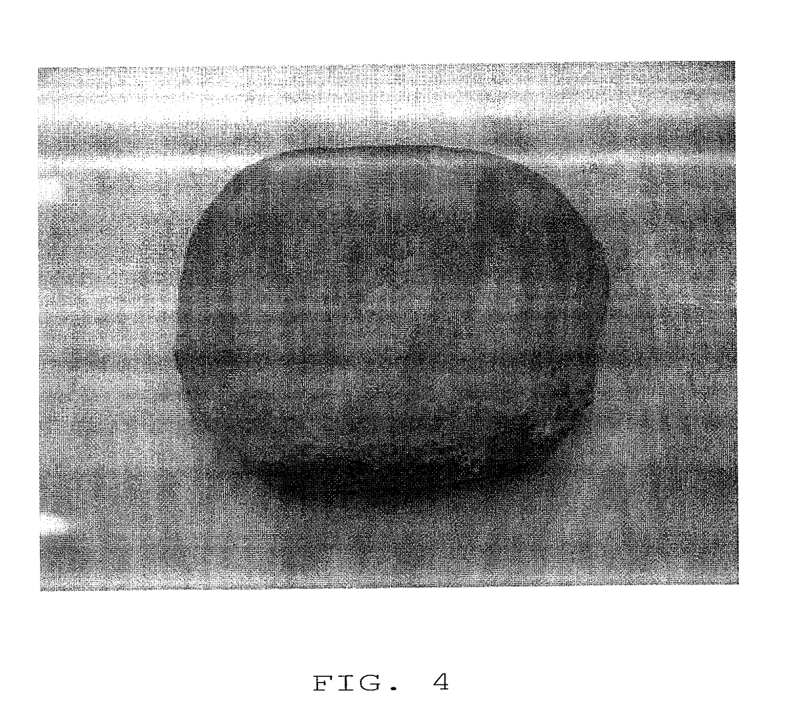

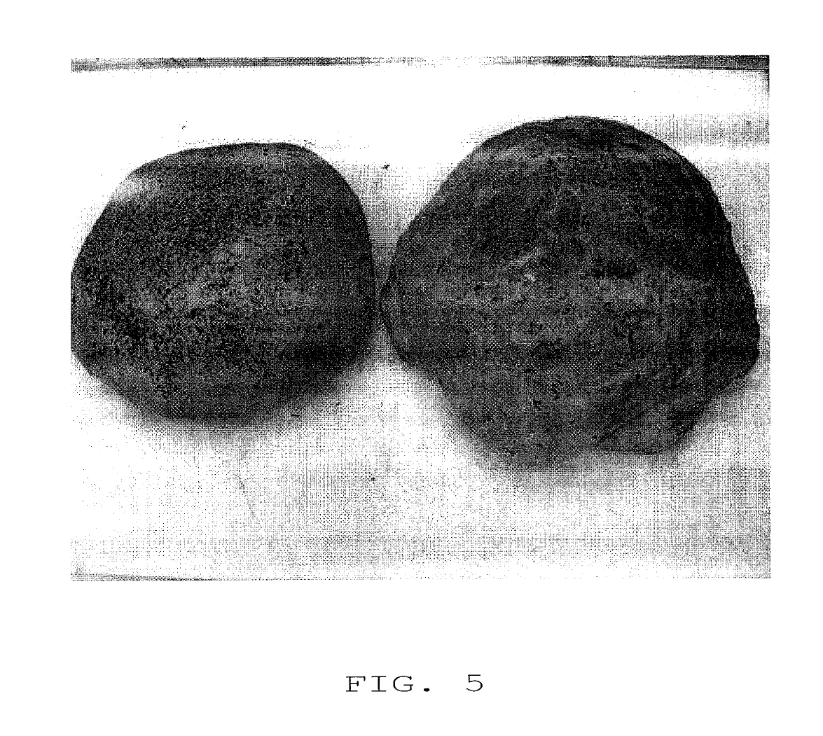

Alternates to container 9 are shown in FIGS. 6A, B. As seen in FIG. 6A, the container 21 can be a pair of tubes 22, 23, one being slidably received in the other to provide a variable or changeable volume. Also, the container 25 (FIG. 6B) is in the form of a fixed volume rigid container base 26 with an attachable lid 27. The lid 27 or the base 26 may also serve as a baking tray if made of ovenable material. The container 25 can also serve the function of the package 2 as well as the container 9.

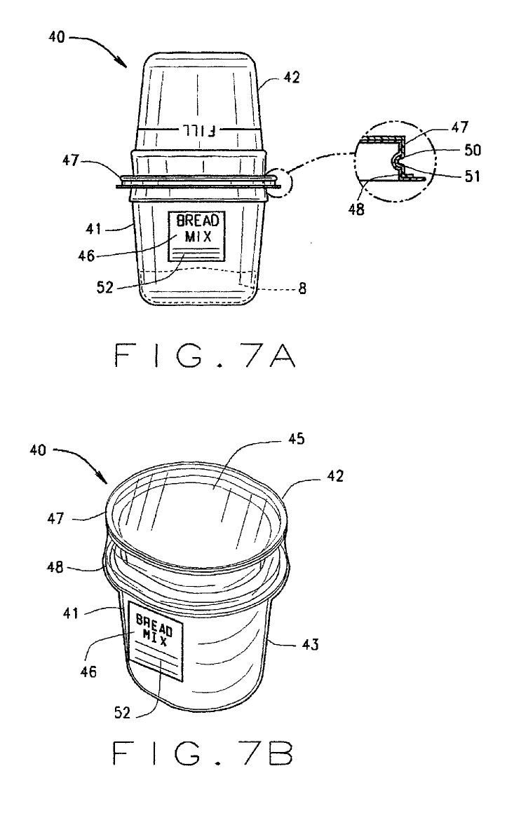

FIGS. 7A, B show a further embodiment of the invention. It includes a container 40 that can substitute for the container 9 and package 2. The container 40 includes a pair of receptacles 41, 42 that have tapered sidewalls permitting nesting of the receptacles in a stack as seen in FIG. 7B. This stacked configuration can be used to form a package configuration to substitute for the package 2. The container 40 may be overwrapped with a transparent shrink wrap 43 to secure the receptacles 41, 42 in nested relationship. The flour 8 and other ingredients may be stored in the inner receptacle 42 and it may be sealed with a lid member 45 that may be heat sealed to the receptacle 42. The container 40 may be labeled with a paste on label or a printed on label 46. The receptacle 41, 42 can be releasably secured together in the superposed configuration shown in FIG. 7A for mixing of the flour 8 and water. As shown, one of the receptacles can have an axially extending peripheral skirt 47 forming a female opening, and the other receptacle can be provided with an axially extending wall portion 48 receivable in the skirt for interengagement therewith. The interengagement can be through a rib 50 on the wall portion 48 or the skirt 47 and a corresponding groove 51 in the other of the wall portion or skirt which will releasably secure the receptacle 41 to the receptacle 42 for mixing and fermentation. The receptacle 42 may be provided with indicia 52 on the label 46 or a side wall to indicate the amount of water recommended to be added to the dry ingredients and the preparation instructions. The instructions may include any suitable language or words informing a person how to prepare and cook the product. For example, any word or words indicating the fermentation and cooking steps can be used. For example, for the fermentation step, the wording may indicate rest, rise, set, ferment, proof or the like, all of which are equivalent for the word ferment, a more technical term. As for the cook step, the word or words could be bake, cook, heat or the like. The receptacle 42 can then serve as a measuring cup if desired and be provide with indicia such as a fill line (FIG. 7A) to indicate the recommended amount of water to be added. The receptacles 41, 42 can be formed as by thermoforming of a suitable plastic such as PET (polyethylene terephthalate). As with the other forms of the invention, other dry ingredients and water may be included in the kit.

The flour 8 may be any suitable flour and contains gluten. The flour may be a blend of different cereal grain flours and preferably contains wheat flour, which can be white flour, whole wheat, or a blend of the two. Other flours contain gluten, e.g., rye, and barley. The total gluten content is in the range of between about 8% and about 14% by weight of flour on a dry weight basis. Gluten is a protein that helps form the gas holding ability of the formed dough that allows the dough to rise from the production of carbon dioxide by the leavener. The flour present in the package for a loaf type bread is in the range of between about 100 gr. and about 600 gr., preferably in the range of between about 200 gr. and about 500 gr., and most preferably in the range of between about 300 gr. and about 400 gr. on a dry weight basis.

Any suitable yeast leavener can be used. Enough yeast should be provided to allow the initial agglomeration to double in volume during the fermentation and quiescent development as described below. Different yeasts will have different carbon dioxide producing capacities. A preferred yeast is dry yeast such as Saccharomyces cerevisiae. Yeast (e.g., active dry yeast), is present in the range of between about 0.1% and about 6% by weight of flour on a dry weight basis. If the agglomeration does not contain a significant amount of sugar, the most desired range of dry yeast is between about 0.1% and about 1% by weight of flour on a dry weight basis. Preferably, the yeast is packaged separately and in a moisture and air resistant package 15. However, the yeast may be premixed with the flour 8 and stored with the flour in the container 9.

Other ingredients may be included and can be provided in a separate package, or if dry, in the flour like the yeast described above. One such ingredient might be a flavor provider such as dry bacterial cultures of selected strains of lactic acid; bacteria can be added to produce a sour dough type of product.

Hydrocolloid may be added, such as a mixture of xanthan and guar gum. The amount of water can exceed the above described amount to accommodate the gum. This can increase chewiness to make a Ciabatta type of bread with a chewy texture. One example was using 1.0% (total agglomeration content basis) of this gum mixture, and 50% formula added water. This is 100 grams water per 100 grams of flour (as is) and 127 grams of total water per 100 grams of flour (dry basis). At this level of water, dough is relatively sloppy if no gum is included. With the gum, it is a nice dough and baked to a very nice final product.

Other ingredients may be included such as flavorings, salt, sugar, butter, oil, food particulates such as dried fruit and dough conditioners. They may be premixed with the flour or can be provided in separate packages (not shown).

The above described packaged food product is adapted for sale at retail outlets such as grocery stores. It is provided for the household production of bread like items such as artisan bread. The produced agglomeration may also be divided to produce smaller items such as demi-loaves or dinner rolls. The dough may also be flattened and shaped after fermentation and before cooking to use as a very high quality pizza crust.

It was surprisingly found that by simply shaking the flour with the added water in at least a substantially closed container that an initial agglomeration could be produced, which, following an extended fermentation and development step, would make a high quality baked product. The container may be completely closed. However, the agglomeration immediately after formation, had an appearance as seen in FIG. 3 that would indicate that a quality baked product was not going to be produced. It was non uniform in appearance and texture and the flour was not uniformly hydrated as discussed below. No traditional mixing with a mechanical mixer such as a dough mixer, a hand held mixer or even mixing with the hands by kneading is needed. A moisture content test was conducted on the dough precursor, the initial agglomeration, prepared in accordance with the present invention and dough prepared by conventional mixing. The inventive agglomeration as formed by shaking was tested for moisture throughout at 24 locations, as was conventionally mixed dough. The samples were then dried to determine the amount of water in each sample. The moisture content in the inventive agglomeration ranged from 0.76 to 0.95 (g H2O/g dry mix) and had a standard deviation 19 times (0.0552 versus 0.0029) the moisture content of the conventionally mixed dough which had a moisture content range of between about 0.84 and 0.85. Another mass of inventive dough, after it was fermented and developed for 24 hours, had a more uniform moisture content, but did not reach the uniformity of mechanically mixed dough. This second dough formed by shaking had a standard deviation found to be 0.034 (as compared to 0.0552) gram water/gram dry matter and the moisture content ranged from 0.854 to 1.012. But, surprisingly, when baked, the dough formed by shaking is equal to or superior in quality to baked mechanically mixed dough.

The flour, leavener and other ingredients that are to be part of the dough are placed in a mixing container adapted to be shaken, such as the container 9, 21, 25 or 40. The water is then added to the container and the container is closed, at least substantially, to prevent loss of ingredients. The ingredients are mixed at room temperature preferably above about 65° F. (18° C.). The order of ingredient addition to the container for mixing is not important. The dry ingredients may be first added and shaken to obtain mixing thereof prior to water addition if desired. The flour, salt, yeast and other dry ingredients may already be preblended and contained in the container 9, 21, 25 or 40 depending on the particular execution of the product 1 and its package 2. The container 9 may be a water impermeable flexible bag, a rigid utensil with a receptacle and lid, which can be a form of package 2 if desired. The flour, water and other ingredients are then shaken until a doughy mass is formed. The agglomeration is then allowed to ferment and quiescently develop without any further mixing. Fermentation and quiescent development can occur in the container 9 or in another location or receptacle as desired. It is preferred that the doughy mass be handled during the fermentation and development at least once in a manner to reduce its volume and then allowed to again rise prior to cooking. Transferring the dough from a fermentation device to a cooking device is a preferred method of accomplishing this.

The fermentation and development are allowed to continue at room temperature until the flour is more uniformly hydrated, the gluten structure is developed, and the flavor typical of artisan bread has been produced. Alternately, if the doughy mass is to be divided to make a plurality of individual items, the agglomeration can be divided prior to fermentation and development. The fermentation is preferably allowed to occur for a time period of at least about 8 hours and more preferably for at least about 24 hours until fermentation and quiescent development is considered complete. It is preferred that the fermented dough has a volume of at least about 1.5 and more preferably at least about 2 times its original formed volume prior to its being cooked. The dough is then transferred to a baking surface or device. This transfer or handling may reduce the dough volume, and the dough after transfer may be allowed to set for a while to permit secondary rising of the dough for approximately 30 minutes for additional increase in specific volume. The dough may be cooked with or without the secondary rise step, i.e. without any appreciable additional rising or fermentation prior to starting the cooking; the cooking is started substantially immediately with some rising occurring during the cooking. A preferred method of cooking is by baking. As is known to one skilled in the art, there is a general relationship of the specific volume of dough (measured as cc's/gram) and the final baked specific volume. Thus, allowing the dough to increase in specific volume just prior to baking results in a final baked product with a larger specific volume. Depending on the texture desired in the product, this may or may not be desirable. The dough can then be cooked as desired, for example, at a temperature above about 350° F. (117° C.) and more preferably above about 400° F. (204° C.) for a time until done as is known in the art. Prior to cooking, flavorants may be applied to the exterior of the dough as can be liquid washes, such as an egg wash. It is preferred to handle the doughy mass as little as is practicable after formation of the agglomeration and before cooking.

FIG. 3 illustrates an agglomeration as mixed in accordance with the above description, and it can be noted the non uniform surface that can be characterized as coarse and irregular or lumpy lacking in surface smoothness. Surprisingly, even with this exterior conformation and non uniform hydration of the flour, a smooth loaf of cooked bread is produced, see FIG. 4.

### Example 1

### Artisan Italian Foccacia

The formula for the bread was as follows:

| | | |
|---|---|---|
| Bread Flour (unbleached) | 57.6% | 350 grams |
| Water (40° C.) (added) | 41.2% | 250 grams |
| Salt | 1.0% | 6 grams |
| Yeast (Active dry) | 0.2% | 1.5 grams |

A dry mix was prepared which contained the flour, salt and yeast. This dry mix was placed in a screw cap high density polyethylene container which was approximately 16 cm in height and 12 cm in diameter. The water was then added to the container and the cap screwed onto the container. The container was then shaken for 15 seconds. The cap was slightly loosened and the container was held at 20° C. for 24 hours. After the 24 hours of fermentation and quiescent development, the dough was transferred from the container to a non-stick baking tray. Twenty grams of olive oil and 1 gram of dried oregano was applied to the surface of the dough. The dough was then baked in a consumer oven at 220° C. for 30 minutes. The baked product was very high quality artisan style bread.

### Example 2

### Rustic Artisan Whole Wheat

The formula for the bread was as follows:

| | | |
|---|---|---|
| Bread Flour (unbleached) | 39.9% | 260 grams |
| Whole Wheat flour | 15.4% | 100 grams |
| Water (40° C.) (added) | 41.5% | 270 grams |
| Sugar (raw) | 2.0% | 13 grams |
| Salt | 0.9% | 6 grams |
| Yeast (Active dry) | 0.3% | 2 grams |

A dry mix was prepared which contained the flours, sugar, salt and yeast. This dry mix was placed in a screw cap high density polyethylene container which was approximately 16 cm in height and 12 cm in diameter. The water was then added to the container and the cap screwed onto the container. The container was then shaken for 15 seconds. The cap was slightly loosened and the container was held at 20° C. for 24 hours. After the 24 hours of fermentation and quiescent development, the dough was transferred from the container to a non-stick baking tray. It was then allowed to rise for approximately 30 minutes. Five grams of whole wheat flour was applied to the surface of the dough. The dough was then baked in a consumer oven at 220° C. for 30 minutes. The baked product was very high quality rustic artisan style whole wheat bread.

### Example 3

### Pan Loaf White Bread

The formula for the bread was as follows:

| | | |
|---|---|---|
| Bread Flour (unbleached) | 54.9% | 350 grams |
| Water (40° C.) (added) | 39.2% | 250 grams |
| Butter (powdered) | 3.1% | 20 grams |
| Sugar (raw) | 1.6% | 10 grams |
| Salt | 0.9% | 6 grams |
| Yeast (Active dry) | 0.3% | 2 grams |

A dry mix was prepared which contained the flour, powdered butter, sugar, salt and yeast. This dry mix was placed in a screw cap high density polyethylene container which was approximately 16 cm in height and 12 cm in diameter. The water was then added to the container and the cap screwed onto the container. The container was then shaken for 15 seconds. The cap was slightly loosened and the container was held at 20° C. for hours. After the 20 hours of fermentation and quiescent development, the dough was transferred from the container to a non-stick loaf style baking pan. It was then allowed to rise for approximately 30 minutes. Five grams of whole wheat flour was applied to the surface of the dough. The dough was then baked in a consumer oven at 220° C. for 30 minutes. The baked product was very high quality loaf of white bread.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A method of making a bread like food item, the method including:
adding a predetermined amount of water to yeast and flour containing gluten, said water being present in an amount of between about 75% and about 125% by weight of dry flour, said flour and added water being in a container;
at least substantially closing said container;
mixing the flour and water by shaking the container and thereby forming an agglomeration of the flour and water;
allowing the agglomeration to ferment and develop to form a doughy mass from the action of yeast for at least about 8 hours; and
cooking the doughy mass.

2. The method of claim 1 wherein the mixing is characterized by an absence of mixing with a mechanical mixing device.

3. The method of claim 2 wherein the fermentation and development is characterized by an absence of punching down the risen dough.

4. The method of claim 1 wherein the container includes a flexible bag.

5. The method of claim 1 wherein yeast is added to the flour prior to the mixing.

6. The method of claim 5 wherein the yeast [leavener], flour and container being provided in a sealed package.

7. The method of claim 6 wherein the added water is included in a container in the sealed package and addition to the flour is accomplished after releasing the water from the water container.

8. The method of claim 6 wherein the doughy mass being allowed to ferment and develop for at least about 24 hours.

9. The method of claim 6 including placing the doughy mass on a cooking utensil prior to cooking the doughy mass.

10. The method of claim 6 wherein the flour including wheat flour.

11. The method of claim 10 wherein the flour has a gluten content of at least about 8% by weight of flour on a dry weight basis.

12. The method of claim 1 wherein the amount of flour is in the range of about 100 gr. and about 600 gr. on a dry weight basis.

13. The method of claim 12 wherein the yeast being present in an amount in the range of between about 0.1% and about 6% by weight of flour on a dry weight basis.

14. The method of claim 12 wherein the yeast being contained in the flour and stored in a container for sale to consumers prior to said shaking.

15. The method of claim 12 wherein the flour being stored in a storage container for sale to consumers and the mixing of the flour and water occurring in the storage container.

16. The method of claim 12 wherein the flour is in the range of between about 200 gr. and about 500 gr. on a dry weight basis.

17. The method of claim 12 wherein the flour is in the range of between about 300 gr. and about 400 gr. on a dry weight basis.

18. The method of claim 12 wherein the water being present in the range of between about 85% and about 110% by weight of flour on dry weight basis.

19. The method of claim 12 wherein the water being present in the range of between about 95% and about 105% by weight of flour on a dry weight basis.

20. The method of claim 12 wherein the doughy mass is handled during the fermentation and is cooked after the handling without any appreciable additional fermentation.

21. The method of claim 1 wherein the development including quiescent development.

22. The method of claim 1 wherein the doughy mass being handled prior to cooking and being allowed to rise after said handling and prior to cooking.

23. The method of claim 1 wherein the volume of the doughy mass being at least about 1.5 times the original volume of the formed agglomeration during said fermentation and development.

24. The method of claim 1 wherein the doughy mass is handled by a person prior to cooking and the doughy mass is allowed additional time to rise prior to cooking.

25. The method of claim 1 wherein the water can be provided from at least one of milk, cream, beer and fruit juice.

26. A product for making a bread like product including:
a sealed package;
flour with gluten in the package;
yeast in the package; and
a first container in the package having a volume potential in excess of the volume of the flour and the yeast in the package and water in an amount in the range of between 75% and about 125% by weight of the flour on a dry weight basis of at least about 200% by volume.

27. The product of claim 25 wherein the flour being contained in the first container, said first container including means to at least substantially seal the first container with the flour therein.

28. The product of claim 27 wherein the yeast being contained in the first container with the flour.

29. The product of claim 26 including water in a sealed second container, said water being present in an amount in the range of between about 75% and about 125% by weight of flour on a dry weight basis.

30. The product of claim 26 including instructions on the package informing a person to mix the flour, the yeast and water in the first container by shaking to form an agglomeration and to allow the agglomeration [a formed dough mass] to ferment for at least about 8 hours.

31. The product of claim 26 wherein the flour is present in the range of between about 100 gr. and about 600 gr. on a dry weight basis.

32. The product of claim 26 wherein the flour is present in the range of between about 200 gr. and about 500 gr. on a dry weight basis.

33. A product for making a bread like product including:
a sealed first container;
flour with gluten in the first container;
yeast in the first container;
the first container having a volume potential in excess of the volume of the flour and the yeast in the first container and water in an amount in the range of between 75% and about 125% by weight of the flour on a dry weight basis of at least about 200% by volume; and
indicia associated with the first container providing instructions to form an agglomeration [a doughy mass] by adding water to the flour and yeast and shaking the water, flour and yeast.

34. The product of claim 33 wherein the first container including a flexible bag with a closure device to selectively close an opening of the bag.

35. The product of claim 33 wherein the first container including a pair of nested receptacles which are adapted to be separated and secured together to form a container for shaking the yeast, the flour and water together to form an agglomeration [a doughy mass] therein.

36. The product of claim 34 including means of securing the receptacles in nested relation and the flour being contained in one of the receptacles.

37. The product of claim 36 wherein the means includes an overwrap.

38. The product of claim 36 including a lid secured to the receptacle containing the flour sealing the flour therein.

39. The product of claim 36 wherein the flour and yeast being mixed together and being in the same receptacle.

40. The product of claim 33 wherein the product includes a package containing the first container.

41. The product of claim 33 wherein the indicia includes instructions to let the agglomeration [doughy mass] ferment for at least 8 hours.
